(19) United States
(12) Patent Application Publication
(10) Pub. No.: US 2021/0063165 A1
(43) Pub. Date: Mar. 4, 2021

(54) ADAPTIVE MAP-MATCHING-BASED VEHICLE LOCALIZATION

(71) Applicant: Mentor Graphics Deutschland (Germany) GmbH, Wilsonville, OR (US)

(72) Inventors: Ljubo Mercep, Munchen (DE); Matthias Pollach, Munchen (DE)

(21) Appl. No.: 16/557,610

(22) Filed: Aug. 30, 2019

(51) Int. Cl. G01C 21/30

(52) U.S. Cl. CPC G01C 21/30

(57) ABSTRACT

This application discloses a computing system to detect a location of a vehicle relative to map data based on correlations between the map data and an environmental model populated with measurement data captured by sensors mounted in the vehicle. The computing system can identify which landmarks in the map data were correlated to the measurement data and utilized to identify the location of the vehicle. The computing system can select a reduced subset of the measurement data in the environmental model expected to correlate to the identified landmarks based on previous correlations to the identified landmarks in the map data over time, other available sources of localization information, or a configuration of the sensors mounted in the vehicle. The computing system can detect a subsequent location of the vehicle by comparing the map data having the identified landmarks with the reduced subset of the measurement data.

### TECHNICAL FIELD

This application is generally related to automated driving and assistance systems and, more specifically, to adaptive map-matching-based vehicle localization.

### BACKGROUND

Many modern vehicles include built-in advanced driver assistance systems (ADAS) to provide automated safety and/or assisted driving functionality. For example, these advanced driver assistance systems can have applications to implement adaptive cruise control, automatic parking, automated braking, blind spot monitoring, collision avoidance, driver drowsiness detection, lane departure warning, or the like. The next generation of vehicles can include autonomous driving (AD) systems to control and navigate the vehicles independent of human interaction.

These vehicles typically include multiple sensors, such as one or more cameras, a Light Detection and Ranging (Lidar) sensor, a Radio Detection and Ranging (Radar) system, or the like, to measure different portions of the environment around the vehicles. Each sensor processes their own measurements captured over time to detect an object within their field of view, and then provide a list of detected objects to an application in the advanced driver assistance systems or the autonomous driving systems to which the sensor is dedicated. In some instances, the sensors can also provide a confidence level corresponding to their detection of objects on the list based on their captured measurements.

The applications in the advanced driver assistance systems or the autonomous driving systems can utilize the list of objects received from their corresponding sensors and, in some cases, the associated confidence levels of their detection, to implement automated safety and/or driving functionality. For example, when a radar sensor in the front of a vehicle provides the advanced driver assistance system in the vehicle a list having an object in a current path of the vehicle, the application corresponding to front-end collision in the advanced driver assistance system can provide a warning to the driver of the vehicle or control vehicle in order to avoid a collision with the object.

Because each application has dedicated sensors, the application can receive a list of objects from the dedicated sensors that provides the application a fixed field of view in around a portion of the vehicle. When multiple sensors for an application have at least partially overlapping fields of view, the application can integrate object lists from its multiple dedicated sensors for the fixed field of view around the portion of the vehicle for the application. Since the vehicle moves, however, having a narrow field of view provided from the sensors can leave the application blind to potential objects. Conversely, widening the field of view can increase cost, for example, due to additional sensors, and add data processing latency.

### SUMMARY

This application discloses a computing system to implement localization in an assisted or automated driving system of a vehicle. The computing system can receive at least a portion of an environmental model populated with measurement data captured by sensors mounted in a vehicle. The measurement data can be temporally aligned and spatially aligned in the environmental model. The computing system can compare the measurement data in the environmental model to map data, and when the comparison identifies a correlation between the measurement data in the environmental model and the map data, detect a location of the vehicle relative to the map data.

The computing system can identify which landmarks in the map data were correlated to the measurement data and utilized to identify the location of the vehicle. For future location detections, the computing system can select a reduced subset of the measurement data in the environmental model expected to correlate to the identified landmarks based on previous correlations to the identified landmarks in the map data over time, other available sources of localization information, or a configuration of the sensors mounted in the vehicle. The computing system can detect a subsequent location of the vehicle by comparing the map data having the identified landmarks with the reduced subset of the measurement data. Embodiments will be described below in greater detail.

### DESCRIPTION OF THE DRAWINGS

FIG. 1 illustrates an example autonomous driving system according to various embodiments.

FIG. 2A illustrates an example measurement coordinate fields for a sensor system deployed in a vehicle according to various embodiments.

FIG. 2B illustrates an example environmental coordinate field associated with an environmental model for a vehicle according to various embodiments.

FIG. 3 illustrates an example sensor fusion system according to various examples.

FIG. 4 illustrates an example localization system according to various examples.

FIG. 5 illustrates an example flowchart for vehicle localization according to various examples.

FIG. 6 illustrates an example flowchart for pre-tracking sensor event detection and fusion according to various embodiments.

FIGS. 7 and 8 illustrate an example of a computer system of the type that may be used to implement various embodiments of the invention.

### DETAILED DESCRIPTION

### Sensor Fusion for Autonomous Driving

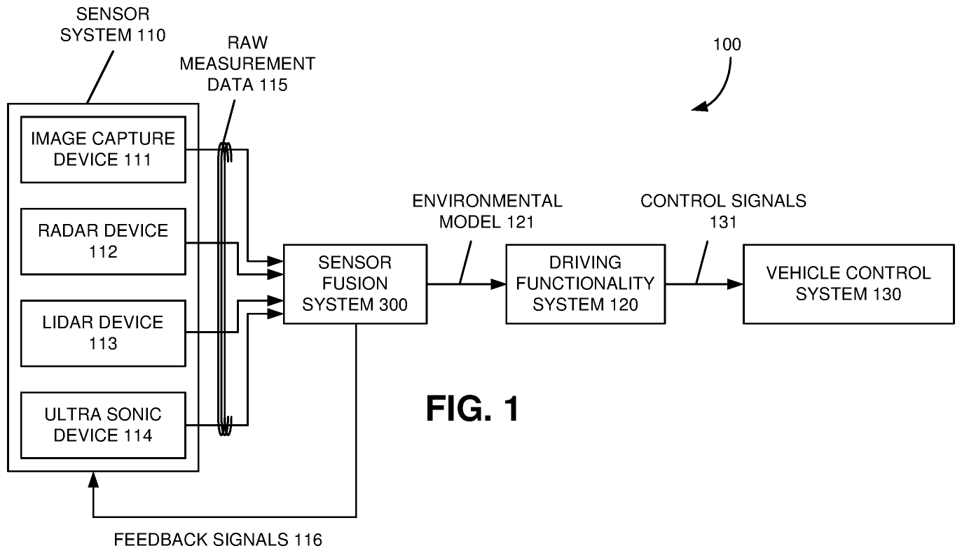

FIG. 1 illustrates an example autonomous driving system 100 according to various embodiments. Referring to FIG. 1, the autonomous driving system 100, when installed in a vehicle, can sense an environment surrounding the vehicle and control operation of the vehicle based, at least in part, on the sensed environment.

The autonomous driving system 100 can include a sensor system 110 having multiple sensors, each of which can measure different portions of the environment surrounding the vehicle and output the measurements as raw measurement data 115. The raw measurement data 115 can include characteristics of light, electromagnetic waves, or sound captured by the sensors, such as an intensity or a frequency of the light, electromagnetic waves, or the sound, an angle of reception by the sensors, a time delay between a transmission and the corresponding reception of the light, electromagnetic waves, or the sound, a time of capture of the light, electromagnetic waves, or sound, or the like.

The sensor system 110 can include multiple different types of sensors, such as an image capture device 111, a Radio Detection and Ranging (Radar) device 112, a Light Detection and Ranging (Lidar) device 113, an ultra-sonic device 114, one or more microphones, infrared or night-vision cameras, time-of-flight cameras, cameras capable of detecting and transmitting differences in pixel intensity, or the like. The image capture device 111, such as one or more cameras, can capture at least one image of at least a portion of the environment surrounding the vehicle. The image capture device 111 can output the captured image(s) as raw measurement data 115, which, in some embodiments, can be unprocessed and/or uncompressed pixel data corresponding to the captured image(s).

The radar device 112 can emit radio signals into the environment surrounding the vehicle. Since the emitted radio signals may reflect off of objects in the environment, the radar device 112 can detect the reflected radio signals incoming from the environment. The radar device 112 can measure the incoming radio signals by, for example, measuring a signal strength of the radio signals, a reception angle, a frequency, or the like. The radar device 112 also can measure a time delay between an emission of a radio signal and a measurement of the incoming radio signals from the environment that corresponds to emitted radio signals reflected off of objects in the environment. The radar device 112 can output the measurements of the incoming radio signals as the raw measurement data 115.

The lidar device 113 can transmit light, such as from a laser or other optical transmission device, into the environment surrounding the vehicle. The transmitted light, in some embodiments, can be pulses of ultraviolet light, visible light, near infrared light, or the like. Since the transmitted light can reflect off of objects in the environment, the lidar device 113 can include a photo detector to measure light incoming from the environment. The lidar device 113 can measure the incoming light by, for example, measuring an intensity of the light, a wavelength, or the like. The lidar device 113 also can measure a time delay between a transmission of a light pulse and a measurement of the light incoming from the environment that corresponds to the transmitted light having reflected off of objects in the environment. The lidar device 113 can output the measurements of the incoming light and the time delay as the raw measurement data 115.

The ultra-sonic device 114 can emit acoustic pulses, for example, generated by transducers or the like, into the environment surrounding the vehicle. The ultra-sonic device 114 can detect ultra-sonic sound incoming from the environment, such as, for example, the emitted acoustic pulses having been reflected off of objects in the environment. The ultra-sonic device 114 also can measure a time delay between emission of the acoustic pulses and reception of the ultra-sonic sound from the environment that corresponds to the emitted acoustic pulses having reflected off of objects in the environment. The ultra-sonic device 114 can output the measurements of the incoming ultra-sonic sound and the time delay as the raw measurement data 115.

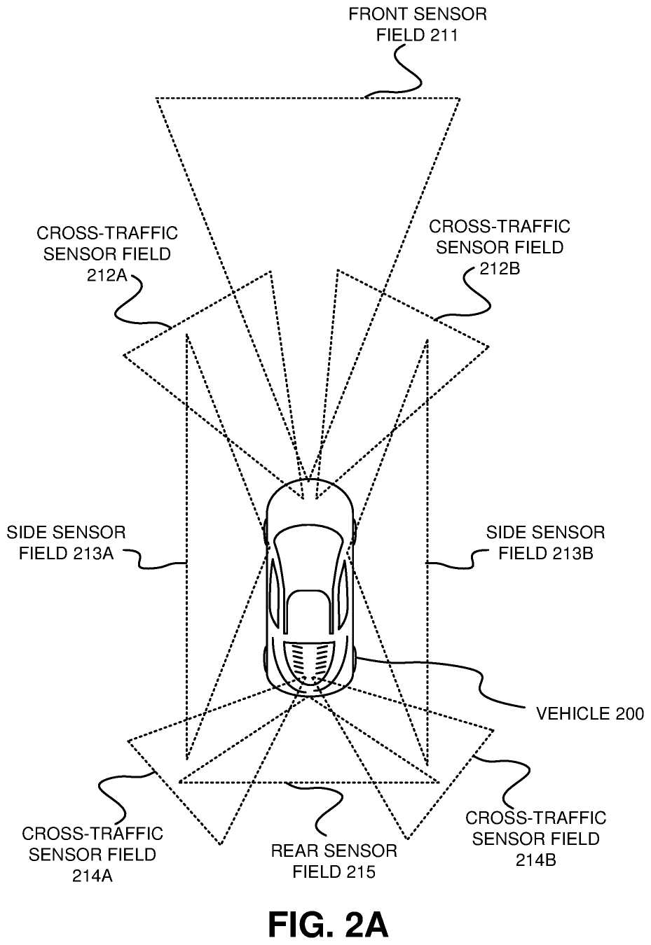

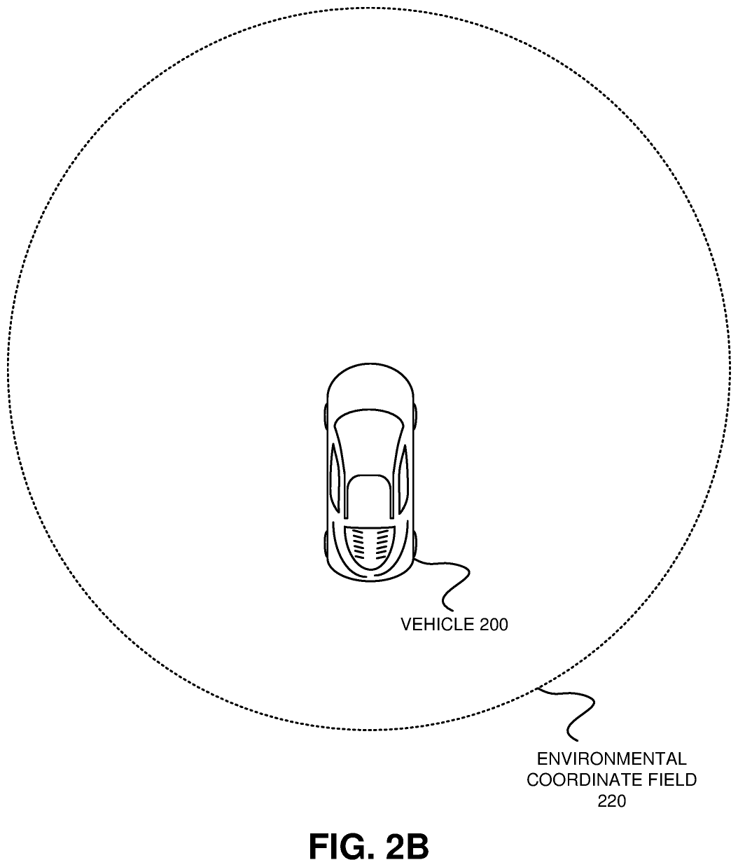

The different sensors in the sensor system 110 can be mounted in the vehicle to capture measurements for different portions of the environment surrounding the vehicle. FIG. 2A illustrates an example measurement coordinate fields for a sensor system deployed in a vehicle 200 according to various embodiments. Referring to FIG. 2A, the vehicle 200 can include multiple different sensors capable of detecting incoming signals, such as light signals, electromagnetic signals, and sound signals. Each of these different sensors can have a different field of view into an environment around the vehicle 200. These fields of view can allow the sensors to measure light and/or sound in different measurement coordinate fields.

The vehicle in this example includes several different measurement coordinate fields, including a front sensor field 211, multiple cross-traffic sensor fields 212A, 212B, 214A, and 214B, a pair of side sensor fields 213A and 213B, and a rear sensor field 215. Each of the measurement coordinate fields can be sensor-centric, meaning that the measurement coordinate fields can describe a coordinate region relative to a location of its corresponding sensor.

Referring back to FIG. 1, the autonomous driving system 100 can include a sensor fusion system 300 to receive the raw measurement data 115 from the sensor system 110 and populate an environmental model 121 associated with the vehicle with the raw measurement data 115. In some embodiments, the environmental model 121 can have an environmental coordinate field corresponding to a physical envelope surrounding the vehicle, and the sensor fusion system 300 can populate the environmental model 121 with the raw measurement data 115 based on the environmental coordinate field. In some embodiments, the environmental coordinate field can be a non-vehicle centric coordinate field, for example, a world coordinate system, a path-centric coordinate field, or the like.

FIG. 2B illustrates an example environmental coordinate field 220 associated with an environmental model for the vehicle 200 according to various embodiments. Referring to FIG. 2B, an environment surrounding the vehicle 200 can correspond to the environmental coordinate field 220 for the environmental model. The environmental coordinate field 220 can be vehicle-centric and provide a 360 degree area around the vehicle 200. The environmental model can be populated and annotated with information detected by the sensor fusion system 300 or inputted from external sources. Embodiments will be described below in greater detail.

Referring back to FIG. 1, to populate the raw measurement data 115 into the environmental model 121 associated with the vehicle, the sensor fusion system 300 can spatially align the raw measurement data 115 to the environmental coordinate field of the environmental model 121. The sensor fusion system 300 also can identify when the sensors captured the raw measurement data 115, for example, by time stamping the raw measurement data 115 when received from the sensor system 110. The sensor fusion system 300 can populate the environmental model 121 with the time stamp or other time-of-capture information, which can be utilized to temporally align the raw measurement data 115 in the environmental model 121. In some embodiments, the sensor fusion system 300 can analyze the raw measurement data 115 from the multiple sensors as populated in the environmental model 121 to detect a sensor event or at least one object in the environmental coordinate field associated with the vehicle. The sensor event can include a sensor measurement event corresponding to a presence of the raw measurement data 115 in the environmental model 121, for example, above a noise threshold. The sensor event can include a sensor detection event corresponding to a spatial and/or temporal grouping of the raw measurement data 115 in the environmental model 121. The object can correspond to spatial grouping of the raw measurement data 115 having been tracked in the environmental model 121 over a period of time, allowing the sensor fusion system 300 to determine the raw measurement data 115 corresponds to an object around the vehicle. The sensor fusion system 300 can populate the environment model 121 with an indication of the detected sensor event or detected object and a confidence level of the detection. Embodiments of sensor fusion and sensor event detection or object detection will be described below in greater detail.

The sensor fusion system 300, in some embodiments, can generate feedback signals 116 to provide to the sensor system 110. The feedback signals 116 can be configured to prompt the sensor system 110 to calibrate one or more of its sensors. For example, the sensor system 110, in response to the feedback signals 116, can re-position at least one of its sensors, expand a field of view of at least one of its sensors, change a refresh rate or exposure time of at least one of its sensors, alter a mode of operation of at least one of its sensors, or the like.

The autonomous driving system 100 can include a driving functionality system 120 to receive at least a portion of the environmental model 121 from the sensor fusion system 300. The driving functionality system 120 can analyze the data included in the environmental model 121 to implement automated driving functionality or automated safety and assisted driving functionality for the vehicle. The driving functionality system 120 can generate control signals 131 based on the analysis of the environmental model 121.

The autonomous driving system 100 can include a vehicle control system 130 to receive the control signals 131 from the driving functionality system 120. The vehicle control system 130 can include mechanisms to control operation of the vehicle, for example by controlling different functions of the vehicle, such as braking, acceleration, steering, parking brake, transmission, user interfaces, warning systems, or the like, in response to the control signals.

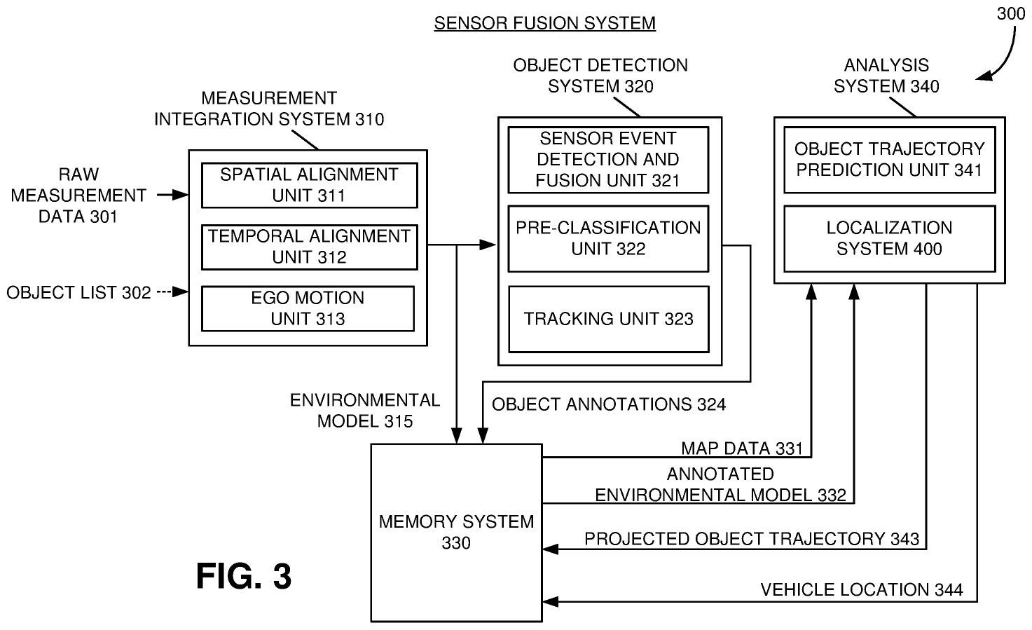

FIG. 3 illustrates an example sensor fusion system 300 according to various examples. Referring to FIG. 3, the sensor fusion system 300 can include a measurement integration system 310 to receive raw measurement data 301 from multiple sensors mounted in a vehicle. The measurement integration system 310 can generate an environmental model 315 for the vehicle, which can be populated with the raw measurement data 301.

The measurement integration system 310 can include a spatial alignment unit 311 to correlate measurement coordinate fields of the sensors to an environmental coordinate field for the environmental model 315. The measurement integration system 310 can utilize this correlation to convert or translate locations for the raw measurement data 301 within the measurement coordinate fields into locations within the environmental coordinate field. The measurement integration system 310 can populate the environmental model 315 with the raw measurement data 301 based on the correlation between the measurement coordinate fields of the sensors to the environmental coordinate field for the environmental model 315.

The measurement integration system 310 also can temporally align the raw measurement data 301 from different sensors in the sensor system. In some embodiments, the measurement integration system 310 can include a temporal alignment unit 312 to assign time stamps to the raw measurement data 301 based on when the sensor captured the raw measurement data 301, when the raw measurement data 301 was received by the measurement integration system 310, or the like. In some embodiments, the temporal alignment unit 312 can convert a capture time of the raw measurement data 301 provided by the sensors into a time corresponding to the sensor fusion system 300. The measurement integration system 310 can annotate the raw measurement data 301 populated in the environmental model 315 with the time stamps for the raw measurement data 301. The time stamps for the raw measurement data 301 can be utilized by the sensor fusion system 300 to group the raw measurement data 301 in the environmental model 315 into different time periods or time slices. In some embodiments, a size or duration of the time periods or time slices can be based, at least in part, on a refresh rate of one or more sensors in the sensor system. For example, the sensor fusion system 300 can set a time slice to correspond to the sensor with a fastest rate of providing new raw measurement data 301 to the sensor fusion system 300.

The measurement integration system 310 can include an ego motion unit 313 to compensate for movement of at least one sensor capturing the raw measurement data 301, for example, due to the vehicle driving or moving in the environment. The ego motion unit 313 can estimate motion of the sensor capturing the raw measurement data 301, for example, by utilizing tracking functionality to analyze vehicle motion information, such as global positioning system (GPS) data, inertial measurements, vehicle odometer data, video images, or the like. The tracking functionality can implement a Kalman filter, a Particle filter, optical flow-based estimator, or the like, to track motion of the vehicle and its corresponding sensors relative to the environment surrounding the vehicle.

The ego motion unit 313 can utilize the estimated motion of the sensor to modify the correlation between the measurement coordinate field of the sensor to the environmental coordinate field for the environmental model 315. This compensation of the correlation can allow the measurement integration system 310 to populate the environmental model 315 with the raw measurement data 301 at locations of the environmental coordinate field where the raw measurement data 301 was captured as opposed to the current location of the sensor at the end of its measurement capture.

In some embodiments, the measurement integration system 310 may receive objects or object lists 302 from a variety of sources. The measurement integration system 310 can receive the object list 302 from sources external to the vehicle, such as in a vehicle-to-vehicle (V2V) communication, a vehicle-to-infrastructure (V2I) communication, a vehicle-to-pedestrian (V2P) communication, a vehicle-to-device (V2D) communication, a vehicle-to-grid (V2G) communication, or generally a vehicle-to-everything (V2X) communication. The measurement integration system 310 also can receive the objects or an object list 302 from other systems internal to the vehicle, such as from a human machine interface, mapping systems, localization system, driving functionality system, vehicle control system, or the vehicle may be equipped with at least one sensor that outputs the object list 302 rather than the raw measurement data 301.

The measurement integration system 310 can receive the object list 302 and populate one or more objects from the object list 302 into the environmental model 315 along with the raw measurement data 301. The object list 302 may include one or more objects, a time stamp for each object, and optionally include a spatial metadata associated with a location of objects in the object list 302. For example, the object list 302 can include speed measurements for the vehicle, which may not include a spatial component to be stored in the object list 302 as the spatial metadata. When the object list 302 includes a confidence level associated with an object in the object list 302, the measurement integration system 310 also can annotate the environmental model 315 with the confidence level for the object from the object list 302.

The sensor fusion system 300 can include an object detection system 320 to receive the environmental model 315 from the measurement integration system 310. In some embodiments, the sensor fusion system 300 can include a memory system 330 to store the environmental model 315 from the measurement integration system 310. The object detection system 320 may access the environmental model 315 from the memory system 330.

The object detection system 320 can analyze data stored in the environmental model 315 to detect a sensor detection event or at least one object. The sensor fusion system 300 can populate the environment model 315 with an indication of the sensor detection event or detected object at a location in the environmental coordinate field corresponding to the detection. The sensor fusion system 300 also can identify a confidence level associated with the detection, which can be based on at least one of a quantity, a quality, or a sensor diversity of raw measurement data 301 utilized in detecting the sensor detection event or detected object. The sensor fusion system 300 can populate the environment model 315 with the confidence level associated with the detection. For example, the object detection system 320 can annotate the environmental model 315 with object annotations 324, which populates the environmental model 315 with the detected sensor detection event or detected object and corresponding confidence level of the detection.

The object detection system 320 can include a sensor event detection and fusion unit 321 to monitor the environmental model 315 to detect sensor measurement events. The sensor measurement events can identify locations in the environmental model 315 having been populated with the raw measurement data 301 for a sensor, for example, above a threshold corresponding to noise in the environment. In some embodiments, the sensor event detection and fusion unit 321 can detect the sensor measurement events by identifying changes in intensity within the raw measurement data 301 over time, changes in reflections within the raw measurement data 301 over time, change in pixel values, or the like.

The sensor event detection and fusion unit 321 can analyze the raw measurement data 301 in the environmental model 315 at the locations associated with the sensor measurement events to detect one or more sensor detection events. In some embodiments, the sensor event detection and fusion unit 321 can identify a sensor detection event when the raw measurement data 301 associated with a single sensor. For example, the sensor event detection and fusion unit 321 can analyze an image captured by a camera in the raw measurement data 301 to identify edges in the image, shapes in the image, or the like, which the sensor event detection and fusion unit 321 can utilize to identify a sensor detection event for the image. The sensor event detection and fusion unit 321 also may analyze groups of intensity points in raw measurement data 301 corresponding to a lidar sensor or groups reflections in raw measurement data 301 corresponding to a radar sensor to determine the a sensor detection event for raw measurement data 301 for those sensors.

The sensor event detection and fusion unit 321, in some embodiments, can combine the identified sensor detection event for a single sensor with raw measurement data 301 associated with one or more sensor measurement events or sensor detection events captured by at least another sensor to generate a fused sensor detection event. The fused sensor detection event can correspond to raw measurement data 301 from multiple sensors, at least one of which corresponding to the sensor detection event identified by the sensor event detection and fusion unit 321.

The object detection system 320 can include a pre-classification unit 322 to assign a pre-classification to the sensor detection event or the fused sensor detection event. In some embodiments, the pre-classification can correspond to a type of object, such as another vehicle, a pedestrian, a cyclist, an animal, a static object, or the like. The pre-classification unit 322 can annotate the environmental model 315 with the sensor detection event, the fused sensor detection event and/or the assigned pre-classification.

The object detection system 320 can include a tracking unit 323 to track the sensor detection events or the fused sensor detection events in the environmental model 315 over time, for example, by analyzing the annotations in the environmental model 315, and determine whether the sensor detection event or the fused sensor detection event corresponds to an object in the environmental coordinate system. In some embodiments, the tracking unit 323 can track the sensor detection event or the fused sensor detection event utilizing at least one state change prediction model, such as a kinetic model, a probabilistic model, or other state change prediction model. The tracking unit 323 can select the state change prediction model to utilize to track the sensor detection event or the fused sensor detection event based on the assigned pre-classification of the sensor detection event or the fused sensor detection event by the pre-classification unit 322. The state change prediction model may allow the tracking unit 323 to implement a state transition prediction, which can assume or predict future states of the sensor detection event or the fused sensor detection event, for example, based on a location of the sensor detection event or the fused sensor detection event in the environmental model 315, a prior movement of the sensor detection event or the fused sensor detection event, a classification of the sensor detection event or the fused sensor detection event, or the like. In some embodiments, the tracking unit 323 implementing the kinetic model can utilize kinetic equations for velocity, acceleration, momentum, or the like, to assume or predict the future states of the sensor detection event or the fused sensor detection event based, at least in part, on its prior states. The tracking unit 323 may determine a difference between the predicted future state of the sensor detection event or the fused sensor detection event and its actual future state, which the tracking unit 323 may utilize to determine whether the sensor detection event or the fused sensor detection event is an object. After the sensor detection event or the fused sensor detection event has been identified by the pre-classification unit 322, the tracking unit 323 can track the sensor detection event or the fused sensor detection event in the environmental coordinate field associated with the environmental model 315, for example, across multiple different sensors and their corresponding measurement coordinate fields.

When the tracking unit 323, based on the tracking of the sensor detection event or the fused sensor detection event with the state change prediction model, determines the sensor detection event or the fused sensor detection event is an object, the object tracking unit 323 can annotate the environmental model 315 to indicate the presence of the object. The tracking unit 323 can continue tracking the detected object over time by implementing the state change prediction model for the object and analyzing the environmental model 315 when updated with additional raw measurement data 301. After the object has been detected, the tracking unit 323 can track the object in the environmental coordinate field associated with the environmental model 315, for example, across multiple different sensors and their corresponding measurement coordinate fields.

The sensor fusion system 300 can include an analysis system 340 to develop information from the environmental model 315 for utilization by automated driving functionality in a vehicle control system. The analysis system 340 can include an object trajectory prediction unit 341 to generate a projected object trajectory 343 of a tracked object proximate to the vehicle. The object trajectory prediction unit 341 can access the annotated environmental model 332 from the memory system 330 or receive them directly from the measurement integration system 310 and/or the object detection system 320. The object trajectory prediction unit 341 can utilize the annotated environmental model 332 along with the state change prediction model corresponding to the tracked object to predict movement of the tracked object relative to the vehicle in the future. Since a tracked object may have a multitude of options for moving in the future, in some embodiments, the object trajectory prediction unit 341 can generate a range of expected trajectories along with probabilities associated with the expected trajectories in the range. The object trajectory prediction unit 341 can annotate the environmental model 315 with the projected object trajectory 343, for example, by storing the projected object trajectory 343 in the annotated environmental model 332 residing in the memory system 330.

The analysis system 340 can include a localization system 400 to utilize the annotated environmental model 332 to determine a location of the vehicle. The localization system 400 can receive the global positioning system (GPS) information and map data 331, for example, from the memory system 330. The map data 331 can include topographical maps, terrain maps, street view maps, or the like, of an area corresponding to a location of the vehicle. The map data 331 can include features, such as roadways, signs, traffic signals, transit crossings, pedestrian crossings, buildings, trees, structures, terrain gradients, topographical edges, photogrammetry, intensity gradients, or the like.

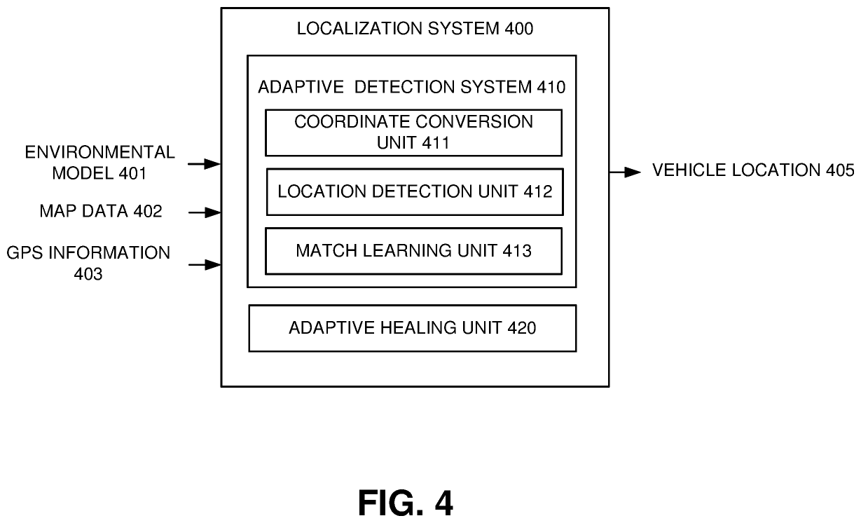

The localization system 400 can correlate data or annotations in the annotated environmental model 332 to landmarks or objects in the map data 331. In some embodiments, the localization system 400 can access the annotated environmental model 332 from the memory system 330 or receive them directly from the measurement integration system 310 and/or the object detection system 320. The correlation between the map data 331 and the annotated environmental model 332 can identify a vehicle location 344 describing a position of the vehicle relative to the map data 331. The localization system 400 also can utilize the annotated environmental model 332 to determine in-lane localization for the vehicle. The in-lane localization can identify the vehicle location 344 describing the position of the vehicle relative to a lane in a roadway. The localization system 400 can selectively perform in-lane localization and map data correlation with the annotated environmental model 332 to identify the vehicle location 344, for example, based on a driving situation, processing resource utilization, or the like. The localization system 400 can output the vehicle location 344, which, in some embodiments, can be stored by the memory system 330 as another annotation to the annotated environmental model 332. Embodiments of vehicle localization will be described in FIGS. 4-6 in greater detail.

### Adaptive Map-Matching-Based Vehicle Localization

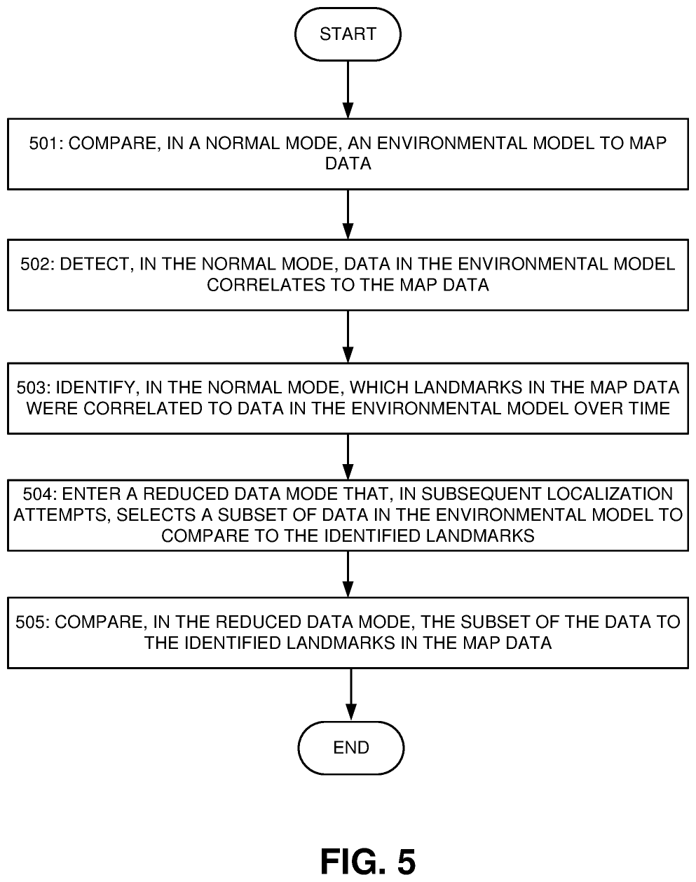

FIG. 4 illustrates an example localization system 400 according to various examples. FIG. 5 illustrates an example flowchart for adaptive map-matching-based vehicle localization according to various examples. Referring to FIGS. 4 and 5, the localization system 400 can receive an environmental model 401 and map data 402, for example, from a memory system 330. The environmental model 401 can include raw measurement data captured by a sensor system and optionally include annotations of detected events, tracked events, tracked objects, or the like. The map data 402 can include topographical maps, terrain maps, street view maps, or the like, of an area corresponding to a location of the vehicle. The map data 402 can include features, such as roadways, signs, traffic signals, transit crossings, pedestrian crossings, buildings, trees, structures, terrain gradients, topographical edges, photogrammetry, intensity gradients, or like. In some embodiments, the map data 402 can include one or more high-definition maps and one or more sparse maps. The sparse maps can include a subset of the data in the high-definition maps, for example, including landmarks or other invariant objects.

In some embodiments, the localization system 400 can receive global positioning system (GPS) information 403, which can provide the localization system 400 a global reference to a location of the vehicle in the map data 402. The localization system 400 can utilize the GPS information 403 to identify a portion of the map data 402 to utilize to attempt to correlate with data in the environmental model 401.

The localization system 400 can include an adaptive detection system 410 to determine a vehicle location relative to a global coordinate field associated with the map data 402. The adaptive detection system 410 can operate in multiple different operational modes, such as a normal mode, a reduced data mode, and a self-healing mode, based, at least in part, on previous correlations between the environmental model 401 to the map data 402. In a block 501, the localization system 400, in a normal mode, can compare an environmental model 401 to map data 402. In some embodiments, the localization system 400 can receive global positioning system (GPS) information 403, which can provide the localization system 400 a global reference to a location of the vehicle in the map data 402. The localization system 400 can utilize the GPS information 403 to identify a portion of the map data 402 to utilize to attempt to correlate with data in the environmental model 401.

The adaptive detection system 410 can include a coordinate conversion system 411 to convert the data in the environmental model 401, such as measurement data, object data, annotations, from an environmental coordinate field into a global coordinate field corresponding to the map data 402, and then compare the converted data to the map data 402. A magnitude of the data converted from the environmental coordinate field to the global coordinate field can vary based on a mode of operation set by the adaptive detection system 410.

The adaptive detection system 410 can include a location detection unit 412 to perform in-lane localization from data in the environmental model 401, which can detect a location of the vehicle relative to a lane on a roadway. In a block 502, the location detection unit 412, in the normal mode, can detect data in the environmental model 401 correlates to the map data 402. In some embodiments, the location detection unit 412 can compare data in the environmental model 401 to data in the map data 402 and determine the environmental model 401 correlates to the map data 402 based on matches between data in the environmental model 401 and the map data 402. For example, the localization system 400 can determine a correlation between the environmental model 401 and the map data 402 after a predetermined number or percentage of matches, or when the matches correspond to invariant landmarks or objects in the map data 402. The location detection unit 412 can utilize the detection of the environmental model 401 correlating to the map data 402 or the in-lane localization to determine a vehicle location 405. The location detection unit 412 can store the vehicle location 405 and/or transformed coordinates in the environmental model 401, for example, as stored in the memory system.

The localization system 400 can include a match learning unit 413 that, in a block 503, can evaluate detected correlations between the environmental model 401 and the map data 402 to identify which landmarks or objects within the map data 402 where invariant to change over time or in different driving conditions, such as weather, traffic congestions, lighting, or the like. In some embodiments, the localization system 400 can identify these landmarks or objects based on whether the landmarks or objects are static in the map data 402, have shapes or profiles allowing for sensor measurement, made of materials allowing for sensor measurement, located to allow unobstructed view by the sensor system, or the like.

The localization system 400 can record correlations of the landmarks in the map data 402 have correlated to data in the environmental model 401 and develop a confidence level of detecting the correlations based on the recorded correlations. The confidence level can correspond to a correlation error rate, for example, based on a presence of erroneous correlations to the landmarks or times when the landmarks should have been correlated to data in the environmental model 401, but were not correlated.

The confidence level also can be based on external factors, such as a time of year or season, the weather conditions, a time of day, traffic conditions, or the like. For example, when the match learning unit 413 can identify records of the environmental model 401 correlating to a landmark in the map data 402 throughout the year, the match learning unit 413 can determine the landmark can be invariant to seasonal differences. In another example, when the match learning unit 413 can identify records of the environmental model 401 correlating to a landmark in the map data 402 in different weather conditions, such as full sun, cloudy, raining, hailing, snowing, foggy, or the like, the match learning unit 413 can determine the landmark can be invariant to weather differences. When the match learning unit 413 can identify records of the environmental model 401 correlating to a landmark in the map data 402 at different times of day, the match learning unit 413 can determine the landmark can be invariant to lighting. When the match learning unit 413 can identify records of the environmental model 401 correlating to a landmark in the map data 402 in different traffic conditions, such as congested or uncongested, the match learning unit 413 can determine the landmark can be invariant to a presence of other objects, such as vehicles, in the environment. The match learning unit 413 can determine the confidence level based on the sensors in the vehicle. In some embodiments, the vehicle may include a mix of sensor types or configurations of the sensors that renders the capture of measurement data for certain landmarks more difficult, for example, due to the size, shape, composition, or the like, of the landmarks.

The match learning unit 413 also can identify a value associated with correlating the environmental model 401 to a landmark in the map data 402 based on a driving situation of the vehicle. For example, when the landmark is located in an area where the vehicle would be on a road having lane geometry, the match learning unit 413 can determine that in-lane localization can be utilized to locate the vehicle, which can lower a value of correlating the environmental model 401 to a landmark in the map data 402. In another example, when the vehicle would be on a highway, the match learning unit 413 can determine a precision of vehicle location can be reduced, for example, due to the high speeds and dearth of non-vehicular objects.

In a block 504, the localization system 400 can enter a reduced data mode that, in subsequent localization attempts, selects a subset of data in the environmental model 401 to compare to the identified landmarks. In some embodiments, the match learning unit 413 can utilize the confidence level, driving situation, and/or configuration of the vehicle sensors to determine the localization system 400 can enter the reduced data mode.

In the reduced data mode, the coordinate conversion unit 411 can convert the subset of the data in the environmental model 401 expected to be correlated to the identified landmarks into the global coordinate field, while keeping other data in the environmental model 401 unconverted. By selectively converting just the subset of the data in the environmental model 401, the localization system 400 can conserve processing, memory, and power supply resources in the vehicle. In the reduced data mode, the location detection unit 412 also can selectively utilize a sparsely populated map, for example, including the identified landmarks, to compare with the subset of data in the environmental model 401. By reducing a quantity of map data for the localization system 400 to analyze for correlation with the environmental model 401, the localization system 400 can reduce utilization of processing resources and associated latency.

In a block 505, the location detection unit 412, in the reduced data mode, can compare the subset of data in the environmental model 401 to the identified landmarks in the map data 402. For example, the localization system can determine a correlation between the environmental model 401 and the map data 402 when matches correspond to invariant landmarks or objects in the map data 402. The localization system 400 can utilize the correlation between the environmental model 401 and the map data 402 in the reduced data mode to determine a location of the vehicle in the global coordinate field.

When the location detection unit 412 is unable to correlate the environmental model 401 to the map data 402, in a normal mode or a reduced data mode, the localization system 400 can enter into a healing mode of operation. The localization system 400 can include an adaptive healing unit 420 to determine the vehicle location 405 in the healing mode, while the detection unit 410 continues attempting to correlate the environmental model 401 to the map data 402.

The adaptive healing unit 420 can track the movement of the vehicle and roughly correlate the tracked movement to the map data 402, for example, based on its last known correlated location. The adaptive healing unit 420 can track the movement of the vehicle based, at least in part, on vehicle movement measurements, such as inertial measurements, vehicle odometer data, video images, or the like, some of which may be included in the environmental model 401. Without an external reference, such as a map data correlation or GPS information 403, the internally tracked vehicle motion can experience drift, where the internally tracked vehicle motion becomes misaligned to the map data 402.

The adaptive healing unit 420 can analyze the environmental model 401 to perform in-lane localization of the vehicle, for example, to determine the vehicle location 405 relative to traffic lines or lanes on a roadway. In some embodiments, the adaptive healing unit 420 can utilize sensor data corresponding to lines on the roads, raised edges of sidewalks, adjacent vehicles or the like, to determine where within a lane the vehicle resides. The adaptive healing unit 420 also can prompt an increased precision in the data within the environmental model 401, for example, by directing the vehicle to reduce speed and/or the sensor system to increase sensor refresh rate, increase captured data precision, or the like.

In some embodiments, the adaptive healing unit 420, while in the healing mode, may determine portions of the map data 402 may be incomplete or missing. In some embodiments, the adaptive healing unit 420 can flag these sections of the map data 402 as incomplete or missing, so a control system for the vehicle proceeds with caution in this area. The adaptive healing unit 420 may build map data by generating data corresponding to the incomplete or missing map data based, at least in part, on the vehicle movement tracking and the measurement data in the environmental model 401.

After the localization unit 400 reacquires an external reference, for example, correlates the environmental model 401 to the map data 402, the localization system 400 may populate the map data 402 with the vehicle movement tracking and/or data in the environmental model 401 for these missing or incomplete sections. The localization system 400 can store data collected during the vehicle movement tracking and/or corrected map data to the memory system for subsequent utilization when traversing that area or to upload the generated map data to an external server for utilization by other vehicles.

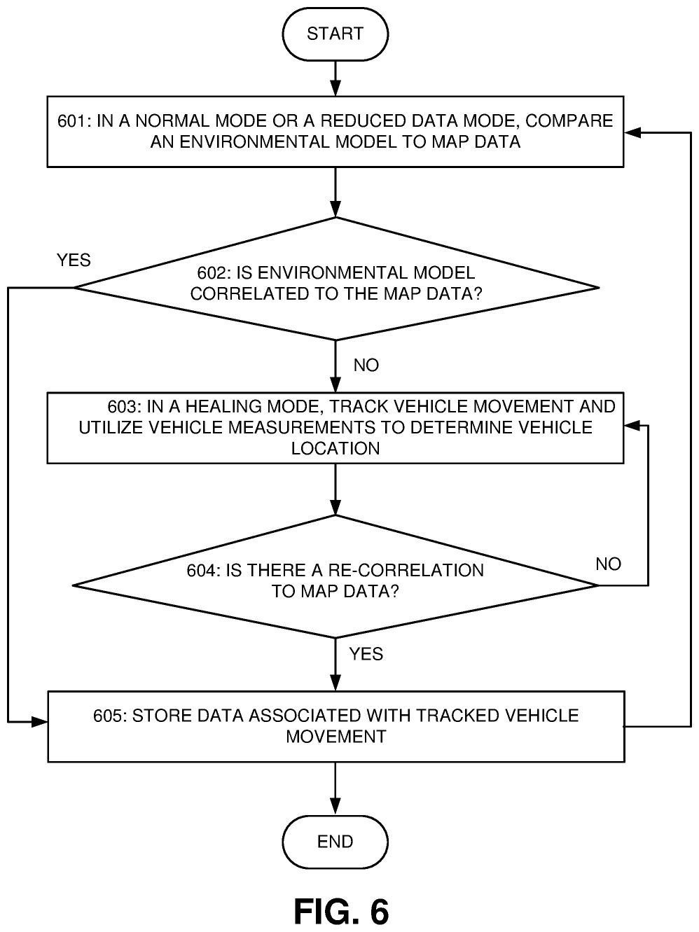

FIG. 6 illustrates an example flowchart for adaptive map-matching-based self-healing according to various examples. Referring to FIG. 6, in a block 601, a localization system, in a normal mode or a reduced data mode, can compare data in an environmental model to map data. The localization system may utilize GPS information to determine which portion of the map data the localization system should compare with the environmental model. The localization system can convert the measurement data or the subset of the measurement data in the environmental model from an environmental coordinate field into a global coordinate field corresponding to the map data, and then compare the converted measurement data to the map data.

The map data can correspond to a detailed map or a sparsely populated map, for example, with a subset of the data in the detailed map. For example, the sparsely populated map may include data corresponding to landmarks or other invariant objects in the detailed map. The localization system can selectively utilize the detailed map and/or the sparsely populated map to compare with the data from the environmental model. The localization system, in the normal mode, also can utilize the environmental model to perform in-lane localization for the vehicle.

In a block 602, the localization system, in the normal mode or the reduced data mode, can determine whether the data or the subset of data in the environmental model correlates to the map data. For example, the localization system can determine a correlation between the environmental model and the map data after a predetermined number or percentage of matches, or when the matches correspond to invariant landmarks or objects in the map data.

When in the decision block 602, the data or the subset of data in the environmental model does not correlate to the map data, execution proceeds to block 603, where the localization system can enter a healing mode. In the healing mode, the localization system can attempt to re-correlate the environmental model to the map data. The localization system also can track vehicle movement and roughly correlate the tracked movement to the map data, for example, based on its last known correlated location or a last known location with matched map data. The localization system can track the movement of the vehicle based, at least in part, on vehicle movement measurements, such as inertial measurements, vehicle odometer data, video images, or the like, some of which may be included in the environmental model.

Also, in the healing mode, the localization system can utilize vehicle measurements to determine vehicle location. The localization system can analyze the environmental model to perform in-lane localization of the vehicle, for example, to determine the vehicle location relative to traffic lines or lanes on a roadway. In some embodiments, the localization system can utilize sensor data corresponding to lines on the roads, raised edges of sidewalks, adjacent vehicles or the like, to determine where within a lane the vehicle resides.

In a decision block 604, the localization system, in the healing mode, can determine whether the environmental model has re-correlated to the map data. In some embodiments, the localization system can continue to compare the environmental model to map data over time. When the localization system determines a correlation between the environmental model and the map data or otherwise acquires the external reference, the localization system can align the internally-generated vehicle location and tracked vehicle movement to the global coordinate field.

When in the decision block 604, the localization system has re-correlated the environmental model to the map data, execution proceeds to block 605, where the localization system can store the data associated with the tracked vehicle movement as corrected map data. Execution can then return back to the block 601. When in the decision block 604, the localization system has re-correlated the environmental model to the map data, execution reverts back to the block 603, where the localization system can continue to track vehicle movement and utilize local measurements to determine vehicle location.

### Illustrative Operating Environment

The execution of various driving automation processes according to embodiments may be implemented using computer-executable software instructions executed by one or more programmable computing devices. Because these embodiments may be implemented using software instructions, the components and operation of a programmable computer system on which various embodiments of the invention may be employed will be described below.

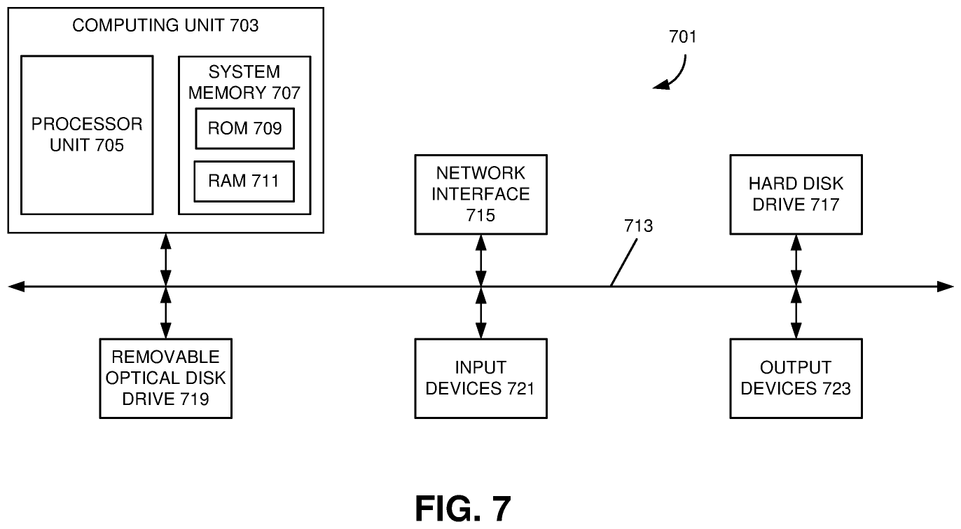

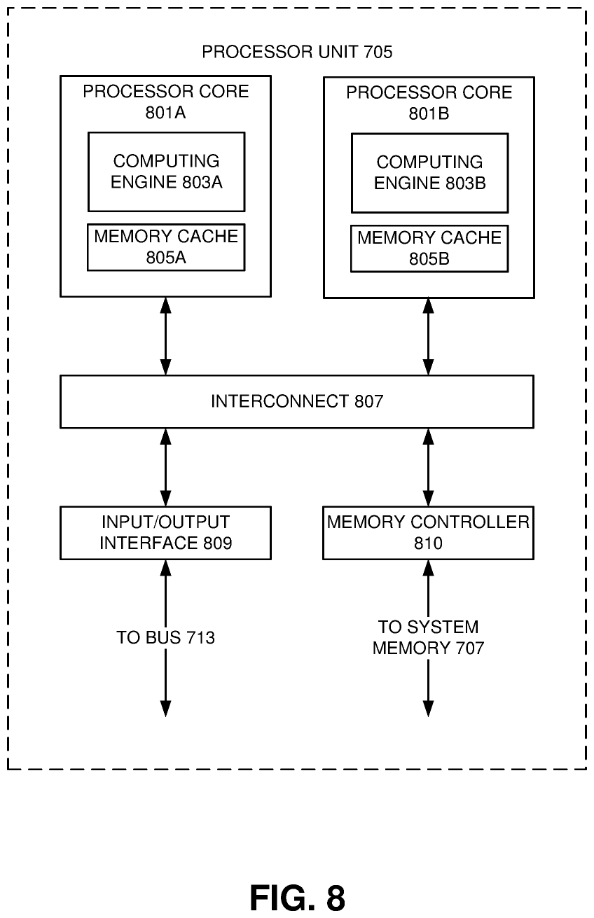

FIGS. 7 and 8 illustrate an example of a computer system of the type that may be used to implement various embodiments. Referring to FIG. 7, various examples may be implemented through the execution of software instructions by a computing device 701, such as a programmable computer. Accordingly, FIG. 7 shows an illustrative example of a computing device 701. As seen in FIG. 7, the computing device 701 includes a computing unit 703 with a processing unit 705 and a system memory 707. The processing unit 705 may be any type of programmable electronic device for executing software instructions, but will conventionally be a microprocessor. The system memory 707 may include both a read-only memory (ROM) 709 and a random access memory (RAM) 711. As will be appreciated by those of ordinary skill in the art, both the read-only memory (ROM) 709 and the random access memory (RAM) 711 may store software instructions for execution by the processing unit 705.

The processing unit 705 and the system memory 707 are connected, either directly or indirectly, through a bus 713 or alternate communication structure, to one or more peripheral devices 717-723. For example, the processing unit 705 or the system memory 707 may be directly or indirectly connected to one or more additional memory storage devices, such as a hard disk drive 717, which can be magnetic and/or removable, a removable optical disk drive 719, and/or a flash memory card. The processing unit 705 and the system memory 707 also may be directly or indirectly connected to one or more input devices 721 and one or more output devices 723. The input devices 721 may include, for example, a keyboard, a pointing device (such as a mouse, touchpad, stylus, trackball, or joystick), a scanner, a camera, and a microphone. The output devices 723 may include, for example, a monitor display, a printer and speakers. With various examples of the computing device 701, one or more of the peripheral devices 717-723 may be internally housed with the computing unit 703. Alternately, one or more of the peripheral devices 717-723 may be external to the housing for the computing unit 703 and connected to the bus 713 through, for example, a Universal Serial Bus (USB) connection.

With some implementations, the computing unit 703 may be directly or indirectly connected to a network interface 715 for communicating with other devices making up a network. The network interface 715 can translate data and control signals from the computing unit 703 into network messages according to one or more communication protocols, such as the transmission control protocol (TCP) and the Internet protocol (IP). Also, the network interface 715 may employ any suitable connection agent (or combination of agents) for connecting to a network, including, for example, a wireless transceiver, a modem, or an Ethernet connection. Such network interfaces and protocols are well known in the art, and thus will not be discussed here in more detail.

It should be appreciated that the computing device 701 is illustrated as an example only, and it not intended to be limiting. Various embodiments may be implemented using one or more computing devices that include the components of the computing device 701 illustrated in FIG. 7, which include only a subset of the components illustrated in FIG. 7, or which include an alternate combination of components, including components that are not shown in FIG. 7. For example, various embodiments may be implemented using a multi-processor computer, a plurality of single and/or multiprocessor computers arranged into a network, or some combination of both.

With some implementations, the processor unit 705 can have more than one processor core. Accordingly, FIG. 8 illustrates an example of a multi-core processor unit 705 that may be employed with various embodiments. As seen in this figure, the processor unit 705 includes a plurality of processor cores 801A and 801B. Each processor core 801A and 801B includes a computing engine 803A and 803B, respectively, and a memory cache 805A and 805B, respectively. As known to those of ordinary skill in the art, a computing engine 803A and 803B can include logic devices for performing various computing functions, such as fetching software instructions and then performing the actions specified in the fetched instructions. These actions may include, for example, adding, subtracting, multiplying, and comparing numbers, performing logical operations such as AND, OR, NOR and XOR, and retrieving data. Each computing engine 803A and 803B may then use its corresponding memory cache 805A and 805B, respectively, to quickly store and retrieve data and/or instructions for execution.

Each processor core 801A and 801B is connected to an interconnect 807. The particular construction of the interconnect 807 may vary depending upon the architecture of the processor unit 705. With some processor cores 801A and 801B, such as the Cell microprocessor created by Sony Corporation, Toshiba Corporation and IBM Corporation, the interconnect 807 may be implemented as an interconnect bus. With other processor units 801A and 801B, however, such as the Opteron™ and Athlon™ dual-core processors available from Advanced Micro Devices of Sunnyvale, Calif., the interconnect 807 may be implemented as a system request interface device. In any case, the processor cores 801A and 801B communicate through the interconnect 807 with an input/output interface 809 and a memory controller 810. The input/output interface 809 provides a communication interface between the processor unit 705 and the bus 713. Similarly, the memory controller 810 controls the exchange of information between the processor unit 705 and the system memory 707. With some implementations, the processor unit 705 may include additional components, such as a high-level cache memory accessible shared by the processor cores 801A and 801B. It also should be appreciated that the description of the computer network illustrated in FIG. 7 and FIG. 8 is provided as an example only, and it not intended to suggest any limitation as to the scope of use or functionality of alternate embodiments.

The system and apparatus described above may use dedicated processor systems, micro controllers, programmable logic devices, microprocessors, or any combination thereof, to perform some or all of the operations described herein. Some of the operations described above may be implemented in software and other operations may be implemented in hardware. Any of the operations, processes, and/or methods described herein may be performed by an apparatus, a device, and/or a system substantially similar to those as described herein and with reference to the illustrated figures.

The processing device may execute instructions or “code” stored in a computer-readable memory device. The memory device may store data as well. The processing device may include, but may not be limited to, an analog processor, a digital processor, a microprocessor, a multi-core processor, a processor array, a network processor, or the like. The processing device may be part of an integrated control system or system manager, or may be provided as a portable electronic device configured to interface with a networked system either locally or remotely via wireless transmission.

The processor memory may be integrated together with the processing device, for example RAM or FLASH memory disposed within an integrated circuit microprocessor or the like. In other examples, the memory device may comprise an independent device, such as an external disk drive, a storage array, a portable FLASH key fob, or the like. The memory and processing device may be operatively coupled together, or in communication with each other, for example by an I/O port, a network connection, or the like, and the processing device may read a file stored on the memory. Associated memory devices may be “read only” by design (ROM) by virtue of permission settings, or not. Other examples of memory devices may include, but may not be limited to, WORM, EPROM, EEPROM, FLASH, NVRAM, OTP, or the like, which may be implemented in solid state semiconductor devices. Other memory devices may comprise moving parts, such as a known rotating disk drive. All such memory devices may be “machine-readable” and may be readable by a processing device.

Operating instructions or commands may be implemented or embodied in tangible forms of stored computer software (also known as “computer program” or “code”). Programs, or code, may be stored in a digital memory device and may be read by the processing device. “Computer-readable storage medium” (or alternatively, “machine-readable storage medium”) may include all of the foregoing types of computer-readable memory devices, as well as new technologies of the future, as long as the memory devices may be capable of storing digital information in the nature of a computer program or other data, at least temporarily, and as long at the stored information may be “read” by an appropriate processing device. The term “computer-readable” may not be limited to the historical usage of “computer” to imply a complete mainframe, mini-computer, desktop or even laptop computer. Rather, “computer-readable” may comprise storage medium that may be readable by a processor, a processing device, or any computing system. Such media may be any available media that may be locally and/or remotely accessible by a computer or a processor, and may include volatile and non-volatile media, and removable and non-removable media, or any combination thereof.

A program stored in a computer-readable storage medium may comprise a computer program product. For example, a storage medium may be used as a convenient means to store or transport a computer program. For the sake of convenience, the operations may be described as various interconnected or coupled functional blocks or diagrams. However, there may be cases where these functional blocks or diagrams may be equivalently aggregated into a single logic device, program or operation with unclear boundaries.

### CONCLUSION

While the application describes specific examples of carrying out embodiments, those skilled in the art will appreciate that there are numerous variations and permutations of the above described systems and techniques that fall within the spirit and scope as set forth in the appended claims.

One of skill in the art will also recognize that the concepts taught herein can be tailored to a particular application in many other ways. In particular, those skilled in the art will recognize that the illustrated examples are but one of many alternative implementations that will become apparent upon reading this disclosure.

Although the specification may refer to “an”, “one”, “another”, or “some” example(s) in several locations, this does not necessarily mean that each such reference is to the same example(s), or that the feature only applies to a single example.

1. A method comprising:
detecting, by a computing system, a location of a vehicle relative to map data based, at least in part, on correlations between the map data and at least a portion of an environmental model populated with measurement data captured by sensors mounted in the vehicle;
identifying, by the computing system, which landmarks in the map data were correlated to the measurement data in the environmental model and utilized to identify the location of the vehicle; and
detecting, by the computing system, a subsequent location of the vehicle by comparing the map data having the identified landmarks with a reduced subset of the measurement data in the environmental model expected to correlate to the identified landmarks.

2. The method of claim 1, wherein identifying the location of the vehicle relative to the map data further comprises:
converting the measurement data from an environmental coordinate field of the environmental model into a global coordinate field of the map data; and
comparing the measurement data having the global coordinate field with the map data to identify correlations between the measurement data and the map data.

3. The method of claim 1, wherein detecting the subsequent location of the vehicle further comprises:
converting the reduced subset of the measurement data from an environmental coordinate field of the environmental model into a global coordinate field of the map data, while leaving other measurement data in the environmental model unconverted; and
comparing the reduced subset of the measurement data having the global coordinate field with the map data to identify correlations between the measurement data and the map data.

4. The method of claim 1, further comprising selecting, by the computing system, the reduced subset of the measurement data in the environmental model based on previous correlations to the landmarks in the map data over time.

5. The method of claim 1, further comprising selecting, by the computing system, the reduced subset of the measurement data in the environmental model based on other available sources of localization information for the computing system.

6. The method of claim 1, further comprising selecting, by the computing system, the reduced subset of the measurement data in the environmental model based on a configuration of the sensors mounted in the vehicle.

7. The method of claim 1, wherein detecting the subsequent location of the vehicle further comprises switching to sparsely-populated map data from higher-definition map data for comparison with the reduced subset of the measurement data.

8. An apparatus comprising at least one memory device storing instructions configured to cause one or more processing devices to perform operations comprising:
detecting a location of a vehicle relative to map data based, at least in part, on correlations between the map data and at least a portion of an environmental model populated with measurement data captured by sensors mounted in the vehicle;
identifying which landmarks in the map data were correlated to the measurement data in the environmental model and utilized to identify the location of the vehicle; and
detecting a subsequent location of the vehicle by comparing the map data having the identified landmarks with a reduced subset of the measurement data in the environmental model expected to correlate to the identified landmarks.

9. The apparatus of claim 8, wherein identifying the location of the vehicle relative to the map data further comprises:
converting the measurement data from an environmental coordinate field of the environmental model into a global coordinate field of the map data; and
comparing the measurement data having the global coordinate field with the map data to identify correlations between the measurement data and the map data.

10. The apparatus of claim 8, wherein detecting the subsequent location of the vehicle further comprises:
converting the reduced subset of the measurement data from an environmental coordinate field of the environmental model into a global coordinate field of the map data, while leaving other measurement data in the environmental model unconverted; and
comparing the reduced subset of the measurement data having the global coordinate field with the map data to identify correlations between the measurement data and the map data.

11. The apparatus of claim 8, wherein the instructions are further configured to cause the one or more processing devices to perform operations comprising selecting the reduced subset of the measurement data in the environmental model based on previous correlations to the landmarks in the map data over time.

12. The apparatus of claim 8, wherein the instructions are further configured to cause the one or more processing devices to perform operations comprising selecting the reduced subset of the measurement data in the environmental model based on other available sources of localization information for the computing system.

13. The apparatus of claim 8, wherein the instructions are further configured to cause the one or more processing devices to perform operations comprising selecting the reduced subset of the measurement data in the environmental model based on a configuration of the sensors mounted in the vehicle.

14. The apparatus of claim 8, wherein detecting the subsequent location of the vehicle further comprises switching to sparsely-populated map data from higher-definition map data for comparison with the reduced subset of the measurement data.

15. A system comprising:
a memory device configured to store machine-readable instructions; and
a computing system including one or more processing devices, in response to executing the machine-readable instructions, configured to:
detect a location of a vehicle relative to map data based, at least in part, on correlations between the map data and at least a portion of an environmental model populated with measurement data captured by sensors mounted in the vehicle;
identify which landmarks in the map data were correlated to the measurement data in the environmental model and utilized to identify the location of the vehicle; and
detect a subsequent location of the vehicle by comparing the map data having the identified landmarks with a reduced subset of the measurement data in the environmental model expected to correlate to the identified landmarks.

16. The system of claim 15, wherein the one or more processing devices, in response to executing the machine-readable instructions, are configured to:
convert the reduced subset of the measurement data from an environmental coordinate field of the environmental model into a global coordinate field of the map data, while leaving other measurement data in the environmental model unconverted; and
compare the reduced subset of the measurement data having the global coordinate field with the map data to identify correlations between the measurement data and the map data.

17. The system of claim 16, wherein the one or more processing devices, in response to executing the machine-readable instructions, are configured to select the reduced subset of the measurement data in the environmental model based on previous correlations to the landmarks in the map data over time.

18. The system of claim 15, wherein the one or more processing devices, in response to executing the machine-readable instructions, are configured to select the reduced subset of the measurement data in the environmental model based on other available sources of localization information for the computing system.

19. The system of claim 18, wherein the one or more processing devices, in response to executing the machine-readable instructions, are configured to select the reduced subset of the measurement data in the environmental model based on a configuration of the sensors mounted in the vehicle.

20. The system of claim 18, wherein the one or more processing devices, in response to executing the machine-readable instructions, are configured to switch to sparsely-populated map data from higher-definition map data for comparison with the reduced subset of the measurement data.
